(19) United States
(12) Patent Application Publication
(10) Pub. No.: US 2025/0367945 A1
(43) Pub. Date: Dec. 4, 2025

(54) SHEET ALIGNING DEVICE AND IMAGE FORMING SYSTEM

(71) Applicant: KYOCERA Document Solutions Inc., Osaka (JP)

(72) Inventors: Ryo MATSUYAMA, Osaka (JP); Shuji OSAKI, Osaka (JP)

(73) Assignee: KYOCERA Document Solutions Inc., Osaka (JP)

(21) Appl. No.: 19/215,239

(22) Filed: May 21, 2025

(30) Foreign Application Priority Data
Jun. 4, 2024 (JP) 2024-090399

(51) Int. Cl. B41J 11/00; B41J 13/08; B41J 13/14

(52) U.S. Cl. CPC B41J 11/0055; B41J 11/00216; B41J 11/007; B41J 11/0085; B41J 13/08; B41J 13/14

(57) ABSTRACT

A sheet aligning device includes a conveying roller, a reference member, and an aligning roller. The conveying roller conveys a sheet along a conveyance path in a predetermined conveyance direction. The reference member defines one boundary of the conveyance path. By the aligning roller, the sheet conveyed by the conveying roller is abutted against the reference member. The aligning roller has a shaft, a first layer, and a second layer provided between the shaft and the first layer and having a hardness lower than that of the first layer.

### INCORPORATION BY REFERENCE

This application is based on and claims the benefit of priority from Japanese patent application No. 2024-090399 Jun. 4, 2024, which is incorporated by reference in its entirety.

### BACKGROUND

The present disclosure relates to a sheet aligning device and an image forming system.

In an image forming apparatus, a sheet is conveyed along a conveyance path passing through an image forming part in which an image is formed on the sheet. When the sheet enters the image forming part in a posture inclined with respect to the conveyance direction, an image is obliquely formed on the sheet. Therefore, it is necessary to correct the inclination of the sheet before entering the image forming part. A registration roller is generally used as a means for correcting the inclination of the sheet, but a configuration in which the sheet is abutted against a reference member provided on the lateral side of the conveyance path is also known.

In the above-described configuration, the sheet is abutted against the reference member by a roller for moving the sheet in a direction intersecting the conveyance direction, but when the sheet is inclined with respect to the conveyance direction, one end of one side of the four sides of the sheet, in which the one side faces the reference member, first is in contact with the reference member, and then the roller moves the sheet. As a result, the sheet buckles before the other end of one side is in contact with the reference member, and the inclination cannot be corrected.

### SUMMARY

A sheet aligning device according to the present disclosure includes a conveying roller, a reference member, and an aligning roller. The conveying roller conveys a sheet along a conveyance path in a predetermined conveyance direction. The reference member defines one boundary of the conveyance path. By the aligning roller, the sheet conveyed by the conveying roller is abutted against the reference member. The aligning roller has a shaft, a first layer, and a second layer provided between the shaft and the first layer and having a hardness lower than that of the first layer.

An image forming system includes the sheet aligning device, and an image forming apparatus which forms an image on the sheet aligned by the sheet aligning device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal structure of an image forming system according to one embodiment of the present disclosure.

FIG. 2 is a perspective view showing a sheet aligning device according to the embodiment of the present disclosure.

FIG. 3 is a plan view showing a main part of the sheet aligning device according to the embodiment of the present disclosure.

FIG. 4 is a schematic view showing the main part of the sheet aligning device according to the embodiment of the present disclosure.

FIG. 5 is a cross-sectional view showing an aligning roller according to the embodiment of the present disclosure.

FIG. 6 is a plan view showing an operation of the sheet aligning device according to the embodiment of the present disclosure.

FIG. 7 is a plan view showing the operation of the sheet aligning device according to the embodiment of the present disclosure.

FIG. 8 is a plan view showing the operation of the sheet aligning device according to the embodiment of the present disclosure.

FIG. 9 is a plan view showing the operation of the sheet aligning device according to the embodiment of the present disclosure.

FIG. 10 is a plan view showing the operation of the sheet matching apparatus according to the embodiment of the present disclosure.

### DETAILED DESCRIPTION

Hereinafter, with reference to the drawings, an image forming system 100 according to one embodiment of the present disclosure will be described.

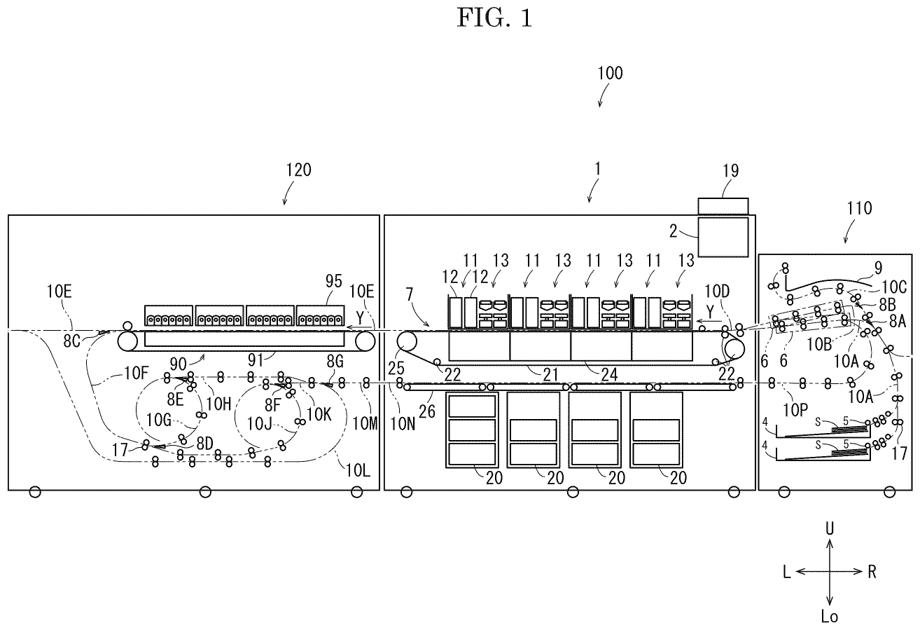

FIG. 1 is a front view schematically showing an internal structure of the image forming system 100. Hereinafter, the front side of the paper plan on which FIG. 1 is drawn is defined as the front side of the image forming system and the left-and-right direction will be described with reference to the direction in which the image forming system 100 is shown from the front side. In each figure, U, Lo, L, R, Fr, and Rr indicate the upper, lower, left, right, front, and rear, respectively.

The image forming system 100 includes a sheet feeding apparatus 110, an inkjet recording apparatus 1, and a drying apparatus 120. The sheet feeding apparatus 110 stores a sheet S, and feeds the sheet S to the inkjet recording apparatus 1. The inkjet recording apparatus 1 forms an image on the sheet S by an inkjet system. The drying apparatus 120 heats the sheet S conveyed from the inkjet recording apparatus 1 to dry the ink. A post-processing apparatus (not shown) for loading the discharged sheet S may be provided on the left side of the drying apparatus 120. The post-processing apparatus may have functions such as staple closing, folding, and drilling.

The sheet feeding apparatus 110 includes a sheet feeding cassette 4, a sheet feeding roller 5, a conveyance path 10A, a sheet aligning device 6, and a retreat tray 9. The sheet feeding cassette 4 stores the stacked sheets S. The sheet feeding roller 5 feeds the sheets S one by one from the sheet feeding cassette 4 to the conveyance path 10A. Two of the sheet aligning devices 6 having the same basic configuration are arranged above and below. The sheet aligning device 6 has a function of correcting the inclination of the sheet S with respect to the conveyance direction A and a function of correcting the displacement of the position of the sheet S in the width direction X crossing the conveyance direction A. The conveyance path 10A communicates with the lower sheet aligning device 6. A conveyance path 10B is branched from the conveyance path 10A and communicates with the upper sheet aligning device 6. A conveyance path 10C is branched from the conveyance path 10B and communicates with the retreat tray 9. The conveyance paths 10A, 10B and 10C are provided with conveyance rollers 17 for conveying the sheet S.

An opening/closing member 8A is provided at a branch point between the conveyance path 10A and the conveyance path 10B, which is turned around an axis to open one of the conveyance path 10A and the conveyance path 10B and to close the other. The sheet S is guided to the conveyance path 10A by opening the conveyance path 10A by the opening/closing member 8A, and the sheet S is guided to the conveyance path 10B by opening the conveyance path 10B by the opening/closing member 8B.

An opening/closing member 8B is provided at a branch point between the conveyance path 10B and the conveyance path 10C, which is turned around an axis to open one of the conveyance path 10B and the conveyance path 10C and to close the other. The sheet S is guided to the conveyance path 10B by opening the conveyance path 10B by the opening/closing member 8B, and the sheet S is guided to the conveyance path 10C by opening the conveyance path 10C by the opening/closing member 8B.

The inkjet recording apparatus 1 includes a conveying unit 7 which attracts and conveys the sheet S in the predetermined conveyance direction Y. Four head units which ejects the ink to form an image are provided above the conveying unit 7. The inkjet recording apparatus 1 includes a conveyance path 10D passing through a gap between the conveying unit 7 and the head units 11. The conveyance path 10A and the conveyance path 10B are merged with a conveyance path 10D.

The conveying unit 7 includes an endless conveying belt 21 and a suction part 24. The conveying belt 21 has a large number of air-holes (not shown), and is wound around a driving roller 25 and a driven roller 22. The upper surface of the suction part 24 has a large number of air-holes (not shown), and is in contact with the inner surface of the conveying belt 21. The suction part 24 sucks air through the air-holes of the conveying belt 21 and the air-hole of the suction part 24, thereby attracting the sheet S to the conveying belt 21. The driving roller 25 is driven in the counterclockwise direction by a drive unit (not shown) including a motor and a reduction gear, whereby the conveying belt 21 travels in the counterclockwise direction, and the sheet S attracted to the conveying belt 21 is conveyed in the Y direction.

Each head unit 11 includes one or more inkjet heads 12. Ink containers 20 filled with the black, cyan, magenta and yellow inks are connected to the respective head units 11. The four head units 11 are arranged at intervals from each other, and a maintenance unit 13 for performing maintenance of the inkjet head 12 is arranged on the right side of each head unit 11.

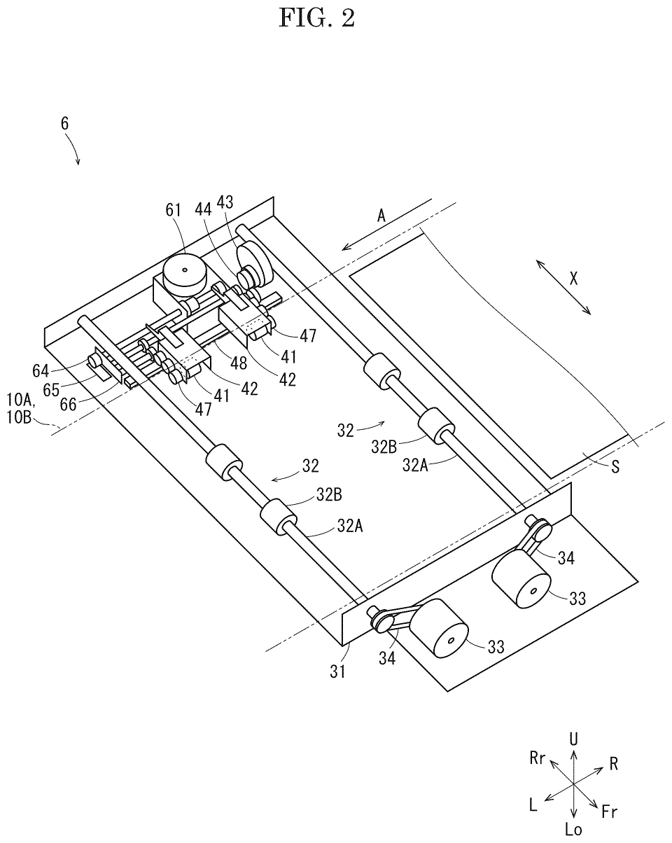

The control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory). The arithmetic part reads and executes the control program stored in the storage part to perform various processes. The control part 2 may be implemented by an integrated circuit that does not use software.

A display operation part 19 includes a display panel, a touch panel laminated on the display panel, and a keypad (not shown). The control part 2 displays a screen showing an operation menu, a status or the like of the inkjet recording apparatus 1 on the display panel, and controls each part of the inkjet recording apparatus 1 according to the operation detected by the touch panel and the keypad.

The drying apparatus 120 includes a conveying unit 90 and a heating unit 95. The conveying unit 90 attracts the sheet S to the conveyance belt 91 by the same principle as that of the conveying unit 7, and conveys the sheet S in the Y direction. The heating unit 95 is provided with a heat source such as an infrared heater to dry the ink on the sheet S.

The drying apparatus 120 includes a conveyance path 10E passing through a gap between the conveying unit 90 and the heating unit 95. The conveyance path 10D is connected to the conveyance path 10E. A conveyance path 10F is branched downward from the conveyance path 10E. The conveyance path 10F is branched into a conveyance path 10G and a conveyance path 10J. The conveyance path 10G and the conveyance path 10J are curved in an arc shape. A conveyance path 10H is branched rightward from the conveyance path 10G, and a conveyance path 10K is branched rightward from the conveyance path 10J. The conveyance path 10H and the conveyance path 10K are merged with a conveyance path 10M. A conveyance path 10L is branched downward from the conveyance path 10M, passes below the conveyance paths 10J, 10G, 10F, and is merged with the conveyance path 10E. The conveyance paths 10E, 10F, 10G, 10H, 10J, 10K, 10L and 10M are provided with conveyance rollers 17 for conveying the sheet S.

An opening/closing member 8C is provided at a branch point between the conveyance path 10E and the conveyance path 10F, which is turned around an axis to open one of the conveyance path 10E and the conveyance path 10F and to close the other. The sheet S is guided to the conveyance path 10E by opening the conveyance path 10E by the opening/closing member 8C, and the sheet S is guided to the conveyance path 10F by opening the conveyance path 10F by the opening/closing member 8C.

An opening/closing member 8D is provided at a branch point between the conveyance path 10G and the conveyance path 10K, which is turned around an axis to open one of the conveyance path 10G and the conveyance path 10K and to close the other. The sheet S is guided to the conveyance path 10G by opening the conveyance path 10G by the opening/closing member 8D, and the sheet S is guided to the conveyance path 10K by opening the conveyance path 10K by the opening/closing member 8C.

An opening/closing member 8E is provided at a branch point between the conveyance path 10G and the conveyance path 10H, which is turned around an axis to open one of the conveyance path 10G and the conveyance path 10H and to close the other. When the sheet S is inverted, the opening/closing member 8E opens the conveyance path 10G, and the conveyance roller 17 conveys the sheet S in the counterclockwise direction until the trailing end of the sheet S entering the conveyance path 10G exceeds the branch point, and then the opening/closing member 8E opens the conveyance path 10H, and the conveyance roller 17 conveys the sheet S in the clockwise direction.

An opening/closing member 8F is provided at a branch point between the conveyance path 10J and the conveyance path 10H, which is turned around an axis to open one of the conveyance path 10J and the conveyance path 10H and to close the other. When the sheet S is inverted, the opening/closing member 8E opens the conveyance path 10J, and the conveyance roller 17 conveys the sheet S in the counterclockwise direction until the trailing end of the sheet S entering the conveyance path 10J exceeds the branch point, and then the opening/closing member 8F opens the conveyance path 10K, and the conveyance roller 17 conveys the sheet S in the clockwise direction.

An opening/closing member 8F is provided at a branch point between the conveyance path 10J and the conveyance path 10M, which is turned around an axis to open one of the conveyance path 10L and the conveyance path 10K and to close the other. The sheet S is guided to the conveyance path 10L by opening the conveyance path 10L by the opening/closing member 8F, and the sheet S is guided to the conveyance path 10M by opening the conveyance path 10M by the opening/closing member 8F.

The inkjet recording apparatus 1 includes a conveyance path 10N connected to the conveyance path 10M, and the sheet feeding apparatus 110 includes a conveyance path 10P extending from the conveyance path 10N to the lower sheet aligning device 6. The conveyance path 10 N includes, for example, an electrostatic adsorption type conveying belt 26 for attracting and conveying the sheet S by static electricity.

The basic operation of the image forming system 100 is as follows. When an image forming job is input to the inkjet recording apparatus 1 from the display operation part 19 or an external computer, the sheet feeding roller 5 feeds the sheet S one by one from the sheet feeding cassette 4 to the conveyance path 10A. Each time the sheet S is fed out, the opening/closing member 8A alternately opens the conveyance path 10A and the conveyance path 10B, and the lower and upper sheet aligning devices 6 alternately perform sheet aligning processing. When the sheet aligning device 6 feeds the sheet S to the conveying unit 7 at a predetermined timing, the conveying unit 7 attracts the sheet S to the conveying belt 21, and conveys the sheet S in the Y direction. When the control part 2 supplies raster type image data to the head units 11 in synchronization with the conveyance of the sheet S, the ink is ejected from the head unit 11 to form an image on the sheet S. The sheet S on which the image is formed is conveyed to the drying apparatus 120.

In the drying apparatus 120, the ink on the sheet S conveyed along the conveyance path 10E is dried. In the case of an image forming job for one-sided printing of only one sheet, the sheet S is guided to the conveyance path 10E and then conveyed to the post-processing apparatus (not shown) connected to the left side of the drying apparatus 120. On the other hand, in the case of the image forming job for one-sided printing of a plurality of the sheets, the sheet S is guided to the conveyance path 10F, and after being inverted by alternately using the conveyance path 10G and the conveyance path 10J, the sheet S is conveyed to the post-processing apparatus via the conveyance path 10L.

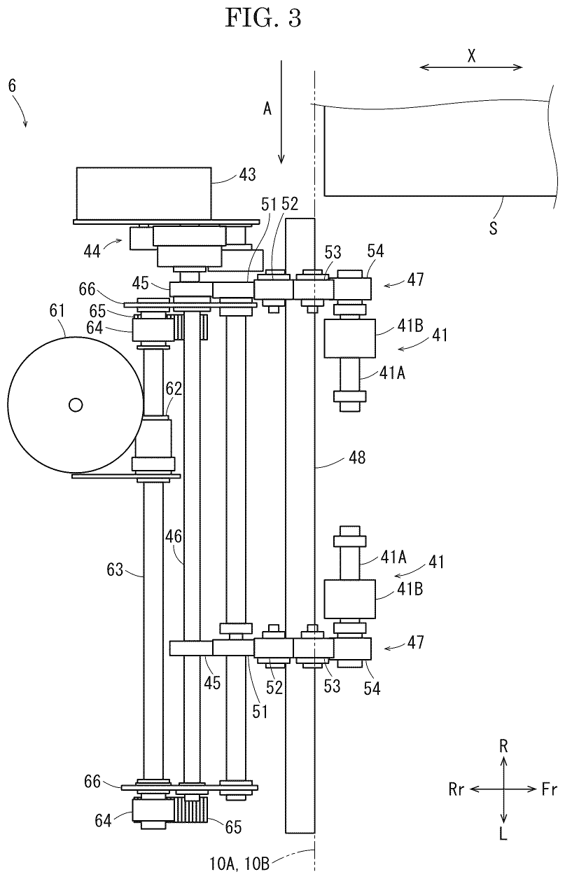

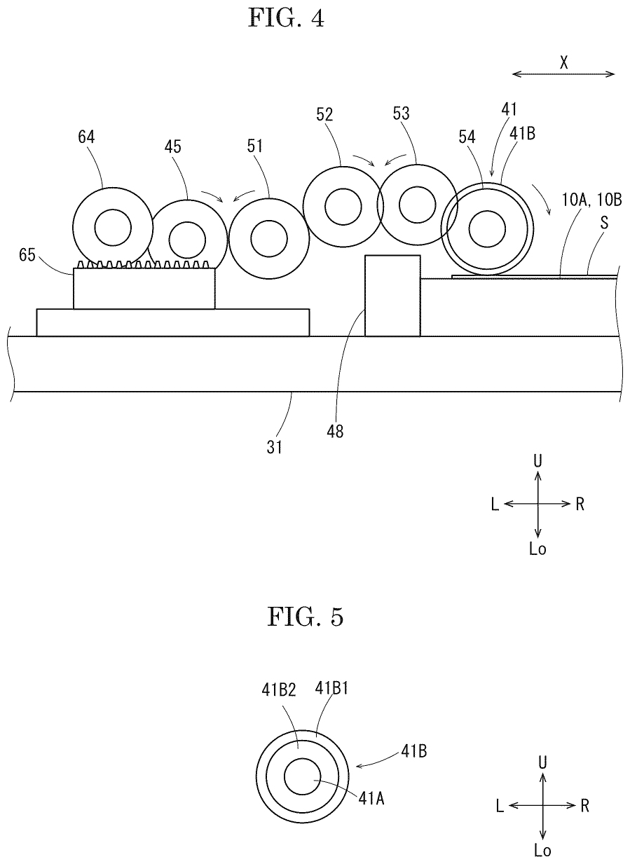

On the other hand, in the case of the image forming job of double-sided printing, the sheet S is inverted by alternately using the conveyance path 10G and the conveyance path 10J, and then conveyed to the lower sheet aligning device 6 via the conveyance paths 10M, 10N, and 10P, and an image is formed on the rear surface by the inkjet recording apparatus 1. After that, the ink is dried by the drying apparatus 120, and after being inverted by alternately using the conveyance path 10G and the conveyance path 10J, the sheet is conveyed to the post-processing apparatus via the conveyance path 10L.

[Sheet Aligning Device] FIG. 2 is a perspective view showing the sheet aligning device 6. FIG. 3 is a plan view showing the main part of the sheet aligning device 6. FIG. 4 is a schematic view showing the main part of the sheet aligning device 6. The sheet aligning device 6 is disposed in a posture in which the conveyance direction A (see FIG. 2 and FIG. 3) of the sheet S is inclined with respect to the horizontal (see FIG. 1), but for convenience of explanation, the conveyance direction A is assumed to be horizontal.

The sheet aligning device 6 includes a frame body 31, a conveying roller 32, an aligning roller 41, and a reference member 48. The frame body 31 is formed in a generally rectangular shape whose front-and-rear direction is longer than the left-and-right direction. The frame body 31 supports various components shown below. The conveying roller 32 has a shaft 32A and a plurality of roller bodies 32B. The conveying roller 32 is provided at two positions of a right end portion and a left end portion of the frame body 31 with the axial direction being along the front-and-rear direction. The conveying roller 32 is driven by a motor 33 via a timing belt 34.

The reference member 48 is disposed on the rear side of the sheet S conveyed by the right conveying roller 32. The reference member 48 is a generally rectangular parallelepiped member whose longitudinal direction is along the left-and-right direction. The aligning roller 41 is provided at two positions between the right and left conveying rollers 32 and on the front side of the reference member 48.

Next, the configuration of the right aligning roller 41 and its periphery will be described. The aligning roller 41 has a shaft 41A and a roller body 41B. The aligning roller 41 is supported by a box-shaped holder 42 with the axial direction being along the left-and-right direction. A driving force of a motor 43 is transmitted to the aligning roller 41 through a gear train 44, a drive gear 45, and a gear train 47 in order. The gear train 47 is provided on the right side surface of the holder 42, and has gears 51, 52, 53 and 54 in order from the rear side. The gear 54 is attached to the right end of the shaft 41A of the aligning roller 41.

The left aligning roller 41 is also provided with the holder 42, the drive gear 45, and the gear train 47 in the same manner as that on the right side. The gear train 47 of the left aligning roller 41 is provided on the left side surface of the holder 42. Since the right and left drive gears 45 are attached to a common shaft 46, the right and left aligning rollers 41 are driven synchronously.

The gear 51 and the drive gear 45 are attached to a connection member 66. A pinion 64 is attached to the connection member 66. The right and left pinions 64 are attached to a common shaft 63, and the shaft 63 is driven by a motor 61 through a worm gear 62. The pinion 64 is meshed with a rack 65 fixed to the frame body 31. By rotation of the pinion 64, the aligning roller 41 is moved rearward and forward through the connection member 66 and the holder 42. With this configuration, the position of the aligning roller 41 in the front-and-rear direction can be adjusted.

FIG. 5 is a cross-sectional view showing the aligning roller 41. The aligning roller 41 includes the shaft 41A and the roller body 41B provided on the shaft 41A. The roller body 41B has at least a first layer 41B1 and a second layer 41B2 provided between the first layer 41B1 and the shaft 41A. A hardness of the second layer 41B2 is lower than that of the first layer 41B1.

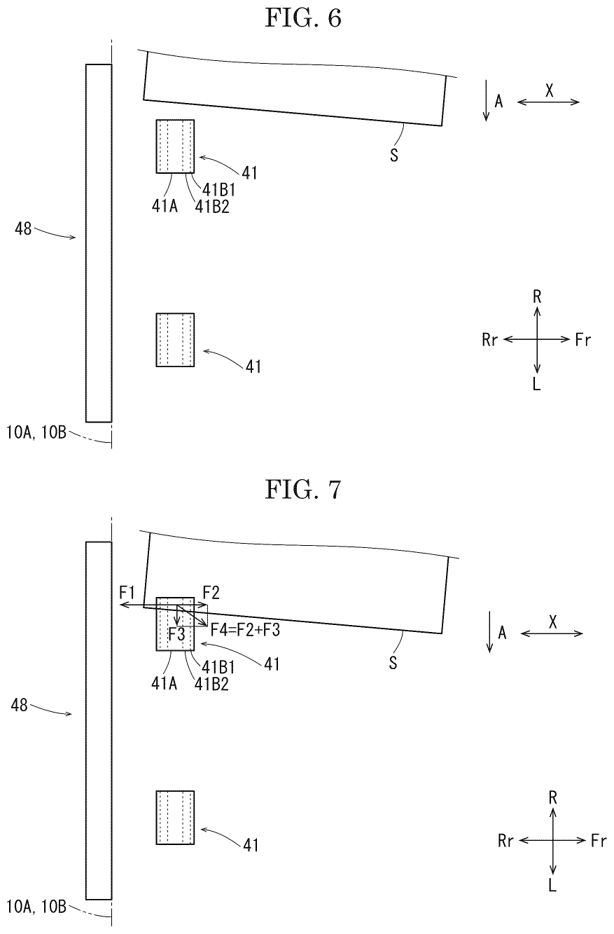

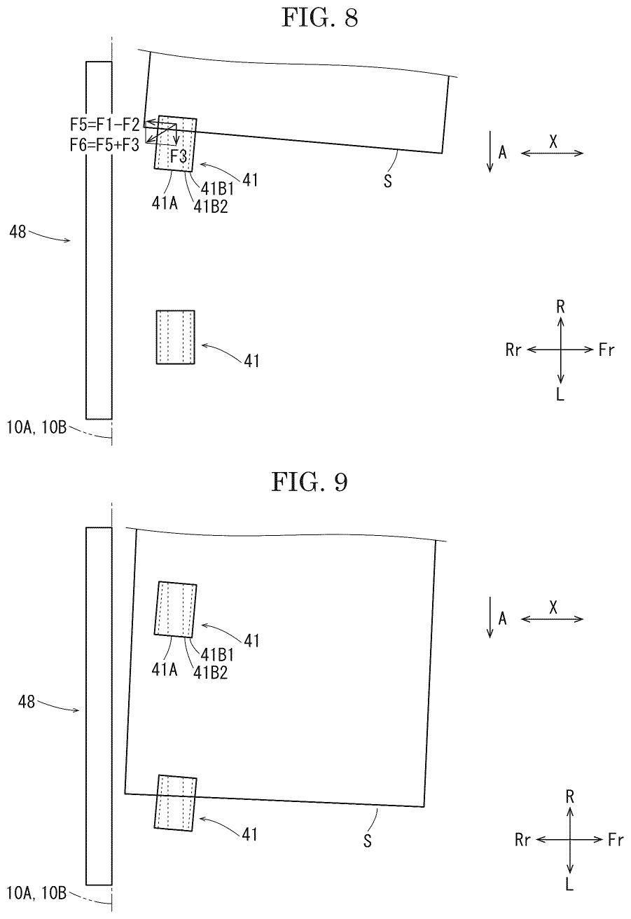

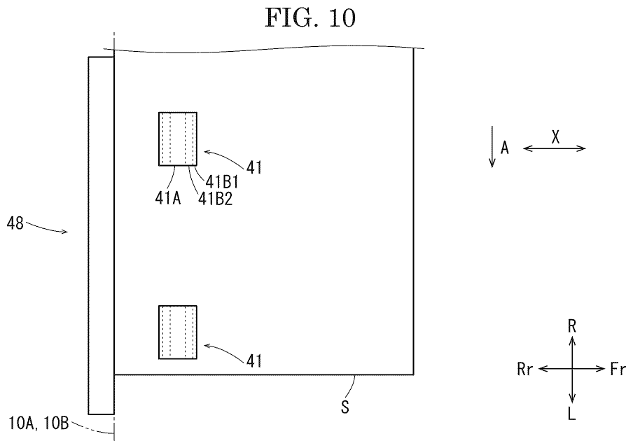

FIG. 6 to FIG. 10 are plan views showing an operation of the sheet aligning device 6. First, the sheet S is conveyed in the direction A by the upstream conveying roller 32 (see FIG. 6), and the leading end of the sheet S enters between the upstream aligning roller 41 in the conveyance direction and the conveyance paths 10A and 10B (see FIG. 7). At this time, the aligning roller 41 applies a rearward conveying force F1 on the sheet S, but the sheet S resists the conveying by a resistive force F2. However, since the conveying force F1 is larger than the resistive force F2, the sheet S is gradually conveyed rearward. The conveying roller 32 conveys the sheet S in the direction A with a conveying force F3. Therefore, a resultant force F4 of the conveying force F3 and the resistive force F2 is applied on the aligning roller 41. Then, since the hardness of the second layer 41B2 is lower than that of the first layer 41B1, the aligning roller 41 is driven under a state where the second layer 41B2 is twisted and the first layer 41B1 is rotated in the clockwise direction (see FIG. 8). Therefore, the aligning roller 41 applies a conveying force F5=F1−F2 to the sheet S in a direction slightly inclined rightward. As a result, a resultant force F6 of the conveying force F5 and the conveying force F3 is applied on the sheet S, and the sheet S is conveyed in the direction A while rotating in the counterclockwise direction. Since the resultant force F6 is larger than the conveying force F5, the sheet S is easily aligned with the reference member 48.

Thereafter, the same behavior as described above occurs in the downstream aligning roller 41 in the conveyance direction A, and the sheet S is conveyed in the direction A with the entire one side of the sheet S in contact with the reference member 48. Thus, the inclination of the sheet S with respect to the conveyance direction A and the displacement of the position of the sheet S in the width direction X are corrected.

Since the conventional aligning roller 41 does not include the second layer 41B2 having a hardness lower than that of the first layer 41B1, the first layer 41B1 cannot be rotated in the clockwise direction. Therefore, since one end of one side of the four sides of the sheet S, one side facing the reference member 48, is first in contact with the reference member 48 and thereafter the aligning roller 41 conveys the sheet S rearward, the sheet S buckles before the other end of one side is in contact with the reference member 48, and the inclination cannot be corrected.

On the other hand, in the present embodiment, since the aligning roller 41 is driven under the state where the second layer 41B2 is twisted and the first layer 41B1 is rotated in the clockwise direction, the sheet S is conveyed in the A direction while rotating, and one side of the sheet S can abut against the reference member 48 without buckling the sheet S.

The sheet aligning device 6 according to the present embodiment described above includes: the conveying roller 32 which conveys the sheet S along the conveyance path 10A in the predetermined conveyance direction A; the reference member 48 which defines one boundary of the conveyance path 10A; and the aligning roller 41 which abuts the sheet S conveyed by the conveying roller 32 against the reference member 48. The aligning roller 41 has the shaft 41A, the first layer 41B1, and the second layer 41B2 provided between the shaft 41A and the first layer 41B1 and having a hardness lower than that of the first layer 41B1. According to the present embodiment, one side of the sheet S can abut against the reference member 48 provided on the lateral side of the conveyance path 10A without buckling the sheet S.

Further, according to the sheet aligning device 6 according to the present embodiment, when the sheet S is conveyed in an inclined posture with respect to the conveyance direction A, a force for rotating the sheet S in a direction of eliminating the inclination of the sheet S is larger than a force for conveying the sheet S by the aligning roller 41. According to the present embodiment, compared with a case where the force for rotating the sheet S in the direction of eliminating the inclination of the sheet S is not larger than the force for conveying the sheet S by the aligning roller 41, the sheet S can be easily aligned with the reference member 48.

According to the sheet aligning device 6 according to the present embodiment, the aligning roller 41 is provided at two positions in the conveyance direction A. According to this embodiment, the sheet S is more easily aligned with the reference member 48 compared with a case where the aligning roller 41 is one.

The image forming system 100 according to the present embodiment includes the sheet aligning device 6 and the image forming apparatus (inkjet recording apparatus 1) which forms an image on the sheet S aligned by the sheet aligning device 6. According to the present embodiment, the inclination and positional deviation of the image can be suppressed.

The above embodiments may be modified as follows.

In the above-described embodiment, the roller body 41B of the aligning roller 41 has the first layer 41B1 and the second layer 41B2, but when comparing the upstream aligning roller 41 with the downstream aligning roller 41 in the conveyance direction A, the upstream aligning roller 41 rotates the sheet S for a longer period, so that the effect of suppressing buckling can be obtained to some extent even if the hardness of the downstream aligning roller 41 is uniform. Therefore, the downstream aligning roller 41 may have uniform hardness.

In the above embodiment, the image forming apparatus is the inkjet recording apparatus 1, but the image forming apparatus may be an apparatus for forming an image by a system other than the inkjet system (for example, electrophotographic system).

1. A sheet aligning device comprising:
a conveying roller which conveys a sheet along a conveyance path in a predetermined conveyance direction;
a reference member which defines one boundary of the conveyance path; and
an aligning roller by which the sheet conveyed by the conveying roller is abutted against the reference member, wherein
the aligning roller has:
a shaft;
a first layer; and
a second layer provided between the shaft and the first layer and having a hardness lower than that of the first layer.

2. The sheet aligning device according to claim 1, wherein
when the sheet is conveyed in an inclined posture with respect to the conveyance direction, a force for rotating the sheet in a direction of eliminating the inclination of the sheet is larger than a force for conveying the sheet by the aligning roller.

3. The sheet aligning device according to claim 1, wherein
the aligning roller is provided at two positions in the conveyance direction.

4. An image forming system comprising:
the sheet aligning device according to claim 1, and
an image forming apparatus which forms an image on the sheet aligned by the sheet aligning device.
